(19) United States
(12) Patent Application Publication
(10) Pub. No.: US 2011/0047938 A1
(43) Pub. Date: Mar. 3, 2011

(54) EXTRUSION METHOD AND SYSTEM FOR PACKAGING SEGMENTS OF A FOOD ITEM

(76) Inventor: Jose L. Medina, Watsonville, CA (US)

(21) Appl. No.: 12/549,167

(22) Filed: Aug. 27, 2009

(51) Int. Cl. B65B 25/04; A47J 25/00; B65B 5/04; B65B 55/18; B65B 63/00

(52) U.S. Cl. 53/435; 99/544; 53/431; 53/471; 53/515; 53/266.1

(57) ABSTRACT

In an automated method for handling and packaging agriculturally grown food items, at least a portion of the exterior of the food item is removed to expose its interior region. From the exposed interior region, a number of food segments are extruded. For example, cylinders of pineapple or watermelon may be extruded. The extruded food segments are then inserted into a number of packaging units, such as single-serving tubes. The extrusion process for forming the food segments may be continuous with the insertion process, such as when the packaging units are located in alignment with movement of a corresponding number of extrusion members. Thus, an automated system may include a mechanized trimmer, a mechanized extrusion unit, and a mechanized packager that provides hands-free insertion of the food segments into the packaging units.

### TECHNICAL FIELD

The present invention relates generally to methods and systems for packaging agriculturally grown food items, particularly fruits and vegetables, and relates more particularly to segmenting and then packaging such food items.

### BACKGROUND ART

Whether fruits or vegetables are marketed intact or following cutting or other segmentation, there are a number of concerns which must be addressed. The food item must be sanitary, the processing and packaging must be cost efficient, the presentation should be appealing to perspective purchasers, and preferably the nutritional value of the food item should not be downgraded. While the concerns are relevant in the marketing of whole (“raw”) fruits and vegetables, the concerns are accented once the food item has been cut. It is estimated that fruit which is at least partially exposed air tends to have a shelf life of 7-10 days after the fruit has been cut. The shelf life for a cut vegetable is generally the same length. Chemical reactions that are accelerated after the cutting of the skin (e.g., the rind) will change the color, flavor, and nutritional properties of the food item. Chemical changes may be enzymatic or non-enzymatic, but in either case the results are undesirable.

Techniques that work well in preserving a fruit or vegetable after a cutting process include sealing the cut food item within a can or a jar. However, as the quantity of the food item within a single can or jar decreases, so does the cost effectiveness of the packaging. That is, it is much less difficult to cost efficiently seal a large volume of a fruit in a can or a jar then to cost effectively provide a single-serving can or jar.

Various other types of containers are described in U.S. Patent Appln. Publn. No. 2006/0249516 to Giumarra. Many of the containers described in Giumarra allow exposure of the food item to air, but the food item is typically uncut. For example, the produce container that is claimed in the Giumarra patent application is an elongated container for storing produce such as berries and grapes, with a removable top and a number of apertures formed in a bottom plate. The apertures in the bottom plate permit ventilation and allow drainage of any produce fluid or condensation from the container.

Regardless of the type of container, the processing and handling of agriculturally grown food items must be carefully considered, particularly if the fruit or vegetable is to be cut prior to packaging. For example, the rind of a watermelon or pineapple provides protection for the fragile edible interior until the watermelon or pineapple is cut. Moreover, sanitation issues are more acute after the food item has been cut.

While many of the known approaches to handling and packaging agriculturally grown food items operate well for their intended purposes, the motivation for improvements remains.

### SUMMARY OF THE INVENTION

In an automated method and system for packaging agriculturally grown food items, the interior region of the food item is exposed so as to permit extrusion of a number of segments from the interior region. The extruded segments of food are then inserted into a number of packaging units. In order to minimize or eliminate the required handling by humans, mechanized techniques are employed to accomplish the exposure of the interior region of the food item, the extrusion of the food segments, and the insertion of the food items into packaging units.

In order to expose the interior region of the food item, at least a portion of the exterior is removed. For example, if the food item is a pineapple or a watermelon, rind is removed. The percentage of removal is dependent upon the extrusion technique. In some applications, only small portions at opposite ends of the food item are removed. This is possible for food items which are relatively cylindrical in shape, such as some types of pineapple. However, other applications may require complete removal of the exterior, such as with food items in which the edible portion is generally spherical, such as some types of watermelon. Still, the preferred embodiment of the invention is one in which the extruded food segments are equal in length, so that the removal process may be used to condition the food item to achieve this goal. As one possibility, exterior portions of the food item may be removed to output the interior region so as to have a cylindrical or box shape.

The extrusion of the food segments from the exposed interior region may be executed using an array of extrusion members in which adjacent extrusion members are parallel to each other. The extrusion members enter the interior region to extrude a corresponding number of food segments. In one embodiment, the extrusion members are cylindrical and each includes a cutting lead edge (such as a serrated lead edge) to facilitate movement of the extrusion members through the interior region. As used herein, the term “extrusion” is defined as establishing the shape of the food segments by applying force through the food item.

The food segments that are extruded from a particular interior region are inserted into a number of packaging units. Typically, there is a one-to-one correspondence between the number of extruded food segments and the number of packaging units, but the alternative is to insert multiple food segments of the same fruit or different fruits into each packaging unit. The shape of the packaging units may correspond to the shape of the extruded food segments. Thus, the packaging units may be tubes and the food segments may be cylindrical. If the food segment has a sufficient length, the packaging unit may be covered and marketed as a single-serving unit for display and sale at store counters or counters at food establishments.

Sanitation and processing efficiency are promoted if the extrusion occurs continuously with the insertion of the food segments into the packaging units. In one embodiment, the packaging units are located immediately below the exposed interior region of the food item as the extrusion occurs, so that the food segments are immediately placed within the packaging units. A first conveyor sequentially moves the food items into the appropriate position, while a second conveyor that is below and at an angle to the first conveyor brings arrays of packaging units into alignment with the position. Preservation of the food segments may be enhanced by providing a fine mist of a citric spray as the extruded food segments are introduced into the packaging units.

Often, the packaging units are then capped. For embodiments in which the packaging unit is a tube, a cap is placed on the tube and the unit is then conveyed to a wash area to remove syrup or any other by-product of the food item. A tamper evident band may be placed on the capped unit using techniques known in the packaging industry.

Other operations may be added. While the mechanized system is preferably designed to eliminate human handling after the interior of the food item is exposed, sanitation remains a concern. Thus, one or more washing cycles may be added. For example, in using the system for packing segments of pineapple, the uncut pineapples may be exposed to a chlorinated wash and a flash pasteurization. Additionally, the removal of the exterior of the pineapple may be followed by a wash process that does not affect the taste or chemistry of the edible interior region.

### BRIEF DESCRIPTION OF THE DRAWINGS

FIG. 1 is a perspective view of an automated system for packaging agriculturally grown food items in accordance with one embodiment of the invention.

FIG. 2 is a top view of the system of FIG. 1, wherein the system is specifically designed for packaging extruded segments of pineapple.

FIG. 3 is a side view of the system of FIG. 2.

FIG. 4 is an end view of the system of FIG. 3.

FIG. 5 is a process flow of steps implemented in the operation of the system of FIG. 1.

FIG. 6 is a side view of one embodiment of a packaging unit for use with the system of FIG. 4.

### DETAILED DESCRIPTION

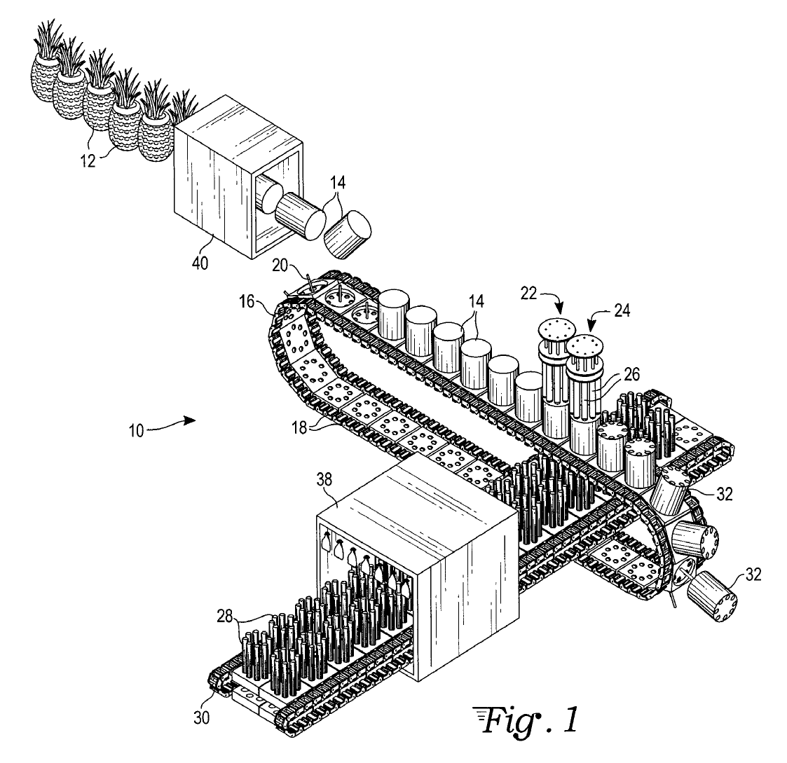

With reference to FIG. 1, one embodiment of an automated system 10 for packaging agriculturally grown food items is illustrated with respect to processing a batch of pineapples 12. “Raw” (or whole) pineapples are partially or wholly stripped of their rinds to expose interior regions 14 of the pineapple. The interior regions are seated onto a first conveyor 16 using techniques which are not significant to the invention. Each seating region of the conveyor includes an array of openings 18 and a center seating member 20 which projects upwardly. While the exterior of each pineapple is removed, the core remains. Thus, when the seating member 20 is extended into the core, the combination of friction and gravitational force securely positions the interior region onto the conveyor.

The interior regions 14 of the pineapples seated on the first conveyor 14 progress to a pair of positions in which extrusion occurs. However, in other embodiments there may be a single extrusion position or there may be more than two extrusion positions. At each such position, an extrusion device 22 and 24 is positioned to move downwardly and upwardly. Each extrusion device includes an array of cylindrical extrusion members 26 that are positioned in alignment with the openings 18 within each seating region of the first conveyor 16. In operation, the extrusion members 26 are pressed downwardly through the interior region of the pineapple, with each extrusion member forming a food segment. In the illustrated embodiment, the extrusion members are parallel to each other and are in a circular array. However, the geometry of the array is not significant to the operation of the system 10. Since the openings within the conveyor are aligned with the extrusion members, these food segments may pass through the conveyor and enter aligned packaging units 28 that are located on a second conveyor 30. Each arrangement of packaging units corresponds to the arrangement of extrusion members, so that the extrusion process and the insertion process are executed continuously. Thus, the “mechanized packager” of this embodiment is merely the second conveyor and the control system for coordinating movements of the system components. In other embodiments, the mechanized packager may be more complex.

Following the extrusion process, each remainder 32 of the interior regions includes passageways from which the food segments have been extruded. The remainder 32 may be used for providing other food products, such as shredded pineapple.

In the embodiment of FIG. 1, eight pineapple segments are extruded from each interior region 14. However, there is no significance to this number. That is, there may be a greater or lesser number of extrusion members 26 for each extrusion device 22 and 24. Of course, an increase or decrease in the number of extrusion members requires a corresponding change in the number of openings 18 within the first conveyor 16 and the number of packaging units 28 within each array on the second conveyor 30.

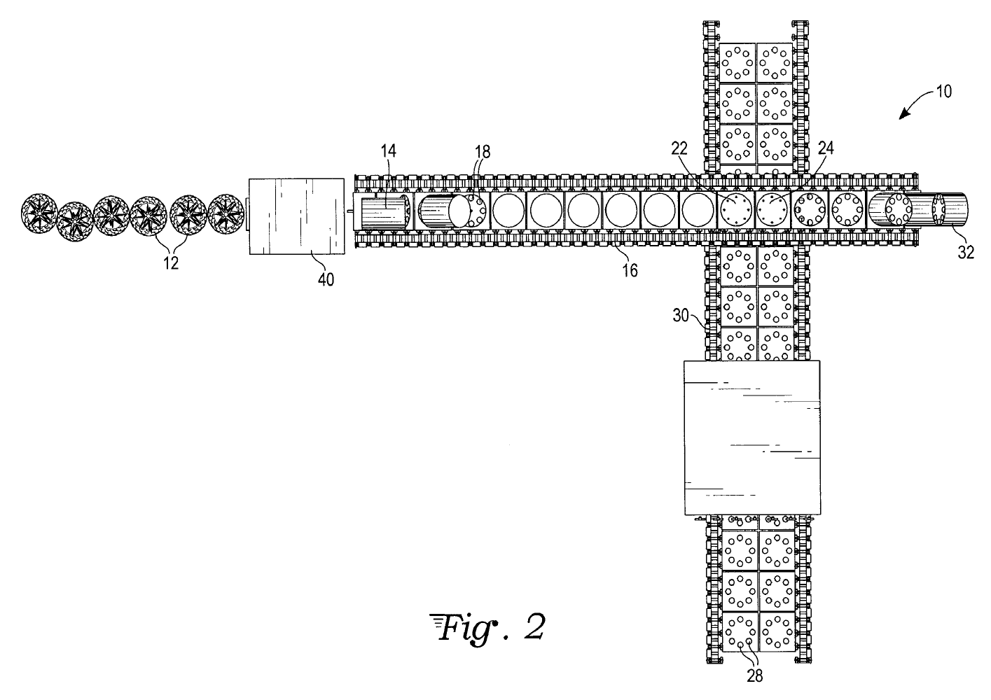

FIGS. 2, 3, and 4 respectively illustrate top, side, and end views of the automated system 10 of FIG. 1. The top view of FIG. 2 more clearly shows the correspondence between the array of openings 18 within the first conveyor 16 and each circular array of packaging units 28 supported on the second conveyor 30. In the preferred embodiment, the extruded segments of pineapple have a cross sectional geometry corresponding to that of the packaging units. For example, the packaging units may be tubes having an internal diameter that is slightly greater than the diameter of cylindrical pineapple segments formed by the extrusion devices 22 and 24. For those embodiments in which each packaging unit receives only one extruded segment, the food segment will also have a lengthwise correspondence with the packaging unit. Thus, the removal of the exterior portions of the pineapple should leave an interior region 14 having a length slightly less than the length or the interior of the packaging unit. However, other embodiments have been contemplated. As one example, the pineapple or other food segment may have a cross sectional geometry unrelated to that of the packaging unit (triangular pineapple segment in a tubular package). As another example of an alternative, each packaging unit may have multiple segments of the same or even different food (pineapple and watermelon segments).

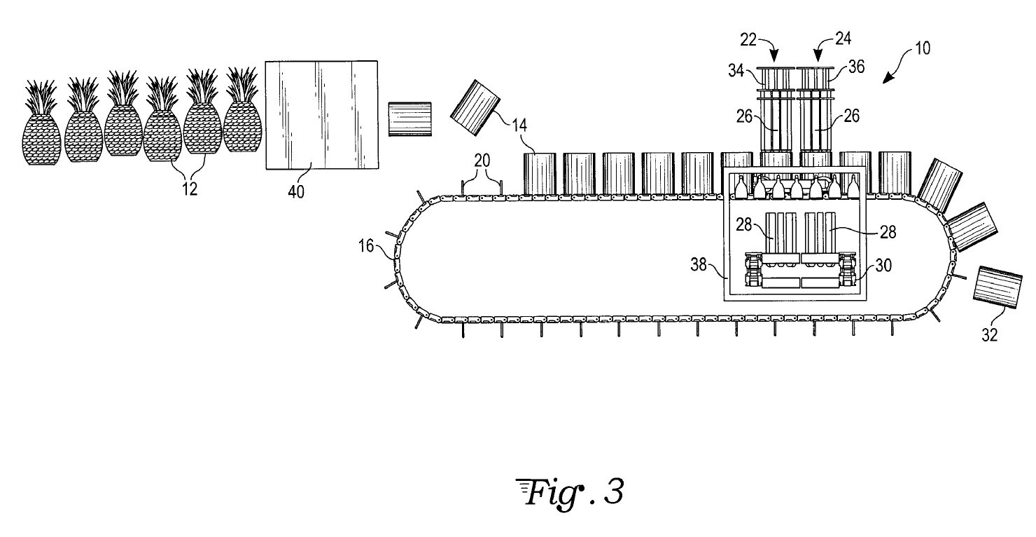

As compared to the top view of FIG. 2, the side view of FIG. 3 provides a better understanding of the extrusion devices 22 and 24. As previously noted, in the illustrated embodiment, each extrusion device includes a circular array of eight cylindrical extrusion members 26. The extrusion devices are operated in unison, so that all sixteen extrusion members simultaneously form a pineapple segment for insertion into its aligned tubular packaging unit 28. Optionally, an upper portion 34 and 36 of each extrusion device may be movable relative to the extrusion members, so that rods extend into the extrusion members and assist in the process of inserting the pineapple segments into the packaging units.

A sanitizer 38 may be considered to be either at the input side of the output side of the second conveyor 30. At the input side, the sanitizer may be used to sterilize the packaging units 28 prior to receiving pineapple segments that are inserted by the extrusion devices 22 and 24. At the output side, the function of the sanitizer is to remove any juices and other by-products of the pineapple from the exterior of the packaging units. The sanitizer preferably includes a capping capability for placing caps on the individual packaging units. The capped and sanitized packaging units may then be sold as single-serving nutritional snacks for sale at grocery and restaurant counters.

While not included within the illustrated embodiment, the automated system 10 may include sanitizers 38 on opposite ends of the second conveyor 30. As a related feature, it has been determined that providing a fine mist of a citric acid spray during insertion of the pineapple segments into the packaging units aids in retarding degradation of the pineapple segments.

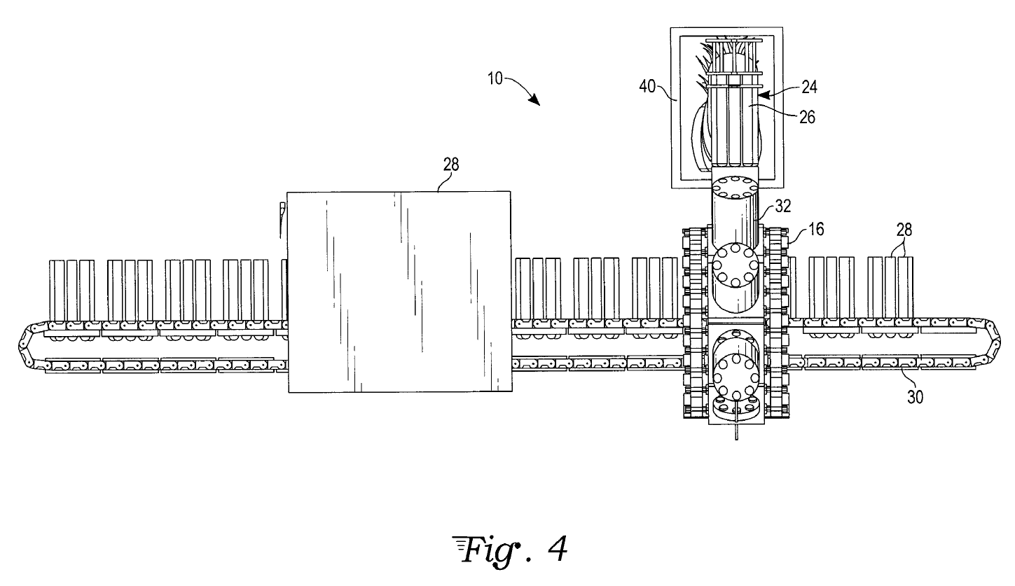

In the side view of FIG. 4, the interior of the sanitizer 38 is no longer visible, but there is alignment with the interior of a preparation component 40 of the system 10. Operations within the preparation component include the removal of at least the portion of the exterior of the pineapple. In the illustrated embodiment, the entirety of the exterior is removed by a mechanized trimmer. The benefit is that the remainder portion 32 following the extrusion process may be more readily converted to shredded pineapple or other usable form. However, persons skilled in the art will recognize that the operations of the extrusion devices 22 and 24 are not inhibited if only the crown and bottom portions of the pineapple are removed. The preparation component preferably also includes a washing capability. For example, the raw pineapples may be exposed to a chlorinated wash and a flash pasteurization. Additionally, the removal of the exterior of the pineapple may be followed by a wash process that does not affect the taste or chemistry of the edible interior region.

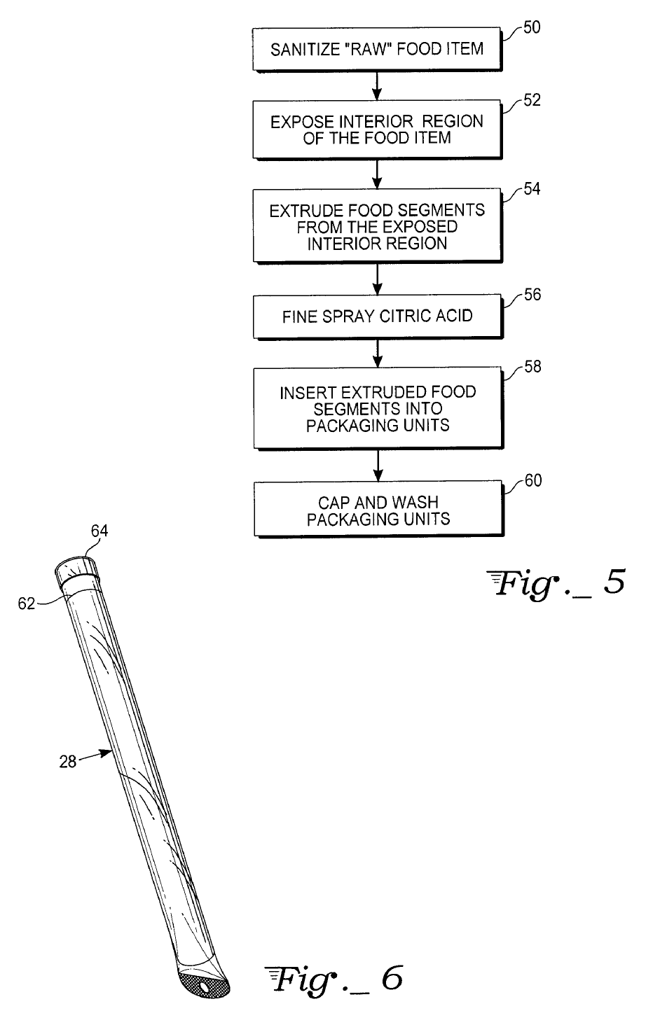

The automated process for packaging agriculturally grown food items in accordance with the invention will be described with reference to FIG. 5. At step 50, the raw food items are prepared for the process. The food items may be pineapples, watermelons, other fruits, or vegetables. As one possibility of the preparation, the food items are exposed to a chlorinated wash and a flash pasteurization. At step 52, the interior region of a food item is exposed. As previously noted, this may be a removal of the entire “skin” of the food item, as shown in the embodiment of FIGS. 1-4. However, there are some applications in which less than all of the “skin” is removed. For example, in the illustrated embodiment, it is only necessary to remove segments at the opposite sides of the food item, since the extrusion members can extend through the food item without interference from side portions of the food item.

At step 54, the extrusion process provides the food segments from the exposed interior region. In the illustrated embodiment, eight pineapple segments are extruded, but the number of the extruded segments is not critical.

A fine spray of citric acid may be applied to the extruded food segments, as indicated at step 56. For some agriculturally grown food items, the spray is helpful in retarding the enzymatic process. In the illustrated embodiment of the invention, steps 54, 56, and 58 occur in a continuous manner. That is, the food segments are extruded and sprayed, with the extrusion providing the means for inserting the food segments into packaging units. Thus, if the packaging units are in alignment with the extrusion members, the exposure of the food segments to a potentially damaging environment is minimized. However, there may be embodiments in which the three steps are performed at different times. For example, the extruded food segments may be placed on a conveyor which carries the food segments to an area for placement within the packaging units.

Finally, at step 60, the packaging units are covered and washed. For example, if the packaging units are tubes, a cap may be placed on each tube in order to contain the food segment. Each capped tube is then conveyed to a wash area to remove any syrup or other by-product of the food item. Tamper evident bands may be placed on the capped tubes and then exposed to heat shrinking in order to mold the tamper evident band to the cap and the tube.

FIG. 6 illustrates one possible end-product of the process. Here, the packaging unit 28 is a transparent plastic tube that allows viewing of an extruded pineapple segment 62. A cap 64 is fixed at the top of the tube. In this embodiment, there is a one-to-one correspondence between the number of extruded pineapple segments and the number of packaging units. As an alternative, each packaging unit may be sufficiently long to receive two or more extruded food items. Then, the arrays of packaging units may be maintained in position during successive extrusion processes, until the packaging units are filled with the desired volume.

What is claimed is:

1. In an automated process for packaging agriculturally grown food items, a method of handling each said food item comprising:
removing at least a portion of an exterior of said food item to expose an interior region of said food item;
extruding a plurality of food segments of said food item from said interior region; and
inserting said plurality of food segments into a plurality of packaging units, wherein said removing, extruding, and inserting are mechanized.

2. The method of claim 1 wherein extruding said food segments is performed such that in cross section each of said food segments has a shape that corresponds to that of said packaging units.

3. The method of claim 2 wherein inserting said food segments into said packaging units is executed such that cylindrical said food segments are individually inserted into cylindrical said packaging units.

4. The method of claim 2 wherein inserting said food segments includes providing a one-to-one correspondence between the number of said food segments and the number of said packaging units.

5. The method of claim 4 further comprising closing each said packaging unit following insertion of one of said food segments.

6. The method of claim 1 wherein said food items are a fruit or a vegetable and wherein removing at least a portion of said exterior includes removing a rind.

7. The method of claim 6 wherein each said food item is one of a pineapple or watermelon.

8. The method of claim 1 wherein said extruding is executed in alignment with said inserting, such that said extruding and inserting are substantially continuous in execution.

9. The method of claim 8 wherein said food item is delivered via a first conveyor and said packaging units are delivered via a second conveyor such that said packaging units reside below said food item during said inserting.

10. An automated system for packaging agriculturally grown food items comprising:
a mechanized trimmer configured to remove at least a portion of an exterior of each said foot item, such that an interior region of said food item is exposed;
a mechanized extrusion unit positioned to receive said food items from said mechanized trimmer, said extrusion unit being configured to extrude a plurality of food segments of each said food item from said exposed interior region thereof; and
a packager operatively associated with said extrusion unit to achieve hands-free insertion of said plurality of said food segments of each said food item into a plurality of packaging units, such that each said food item provides at least one said food segment for each of a plurality of said packaging units.

11. The automated system of claim 10 wherein said extrusion unit includes a plurality of parallel extrusion members configured to define a geometry of said food segments, said extrusion unit including means for providing relative movement between said exposed interior region of one of said food items and said plurality of extrusion members.

12. The automated system of claim 10 wherein said packager is configured to secure an array of said packaging units having a tube shape, said extrusion unit and said packager being cooperative such that each said tube-shaped packaging unit receives a single said food segment.

13. The automated system of claim 12 wherein said extrusion unit includes parallel extrusion members dimensioned to form said food segments as cylindrical food segments.

14. The automated system of claim 10 wherein said mechanized trimmer is specifically configured to remove rind from one of a pineapple or a watermelon.

15. The automated system of claim 10 further comprising a first conveyor which sequentially carries said exposed interior regions of said food items to a position in which said extrusion unit operates to extrude said plurality of said food segments, said packager including a second conveyor which carries said packaging units to and from alignment with said extrusion unit to receive said food segments.

16. A method of packaging segments of an agriculturally grown food item comprising:
exposing an interior region of said food item;
extruding a plurality dimensionally equivalent elongated sections of said food item from said exposed interior region; and
individually inserting each said elongated section into a different packaging unit, such that each said elongated section is packaged separately from other said elongated sections of said food item.

17. The method of claim 16 wherein said extruding forms cylindrical said elongated sections and wherein said packaging units have a tube shape.

18. The method of claim 16 wherein said exposing includes manipulating one of a pineapple or a watermelon.
